(19) United States
(12) Patent Application Publication
(10) Pub. No.: US 2013/0200844 A1
(43) Pub. Date: Aug. 8, 2013

(54) WIRELESS POWER CHARGING METHOD AND APPARATUS

(71) Applicant: Samsung Electronics Co., Ltd., Gyeonggi-do (KR)

(72) Inventors: Kyung-Woo Lee, Gyeonggi-do (KR); Kang-Ho Byun, Gyeonggi-do (KR); Yu-Su Kim, Gyeonggi-do (KR); Sung-Ku Yeo, Gyeonggi-do (KR)

(73) Assignee: Samsung Electronics Co., Ltd., Gyeonggi-do (KR)

(21) Appl. No.: 13/760,818

(22) Filed: Feb. 6, 2013

(30) Foreign Application Priority Data
Feb. 6, 2012 (KR) 10-2012-0012030

(51) Int. Cl. H02J 7/00; H04B 5/00

(52) U.S. Cl. CPC H02J 7/0042; H02J 7/0052; H04B 5/0037; H04B 5/0075
USPC 320/108; 320/162

(57) ABSTRACT

A method and apparatus are provided that efficiently perform wireless power charging. A power supply device checks an amount of charging power required by the power receiving device; determines a power level of the charging power that to be supplied over time, based on the amount of the charging power required by the power receiving device; transmits the charging power corresponding to the determined power level to the power receiving device; periodically receives a report message about a charging situation of the power receiving device from the power receiving device; calculates remaining required power, based on the report message received from the power receiving device; adjusts the determined power level depending on the calculated remaining power; and transmits the charging power corresponding to the adjusted power level to the power receiving device.

### PRIORITY

This application claims priority under 35 U.S.C. §119(a) to Korean Patent Application Serial No. 10-2012-0012030, which was filed in the Korean Intellectual Property Office on Feb. 6, 2012, the entire disclosure of which is incorporated herein by reference.

### BACKGROUND OF THE INVENTION

1. Field of the Invention

The present invention relates generally to a power charging system, and more particularly, to a wireless power charging method and apparatus that efficiently charge a device.

2. Description of the Related Art

Wireless charging technologies wirelessly supply and receive power without a physical connector for power transfer. For example, a wireless charging technology includes an electromagnetic induction scheme that uses coils, a wireless power transmission scheme that delivers electrical energy by converting it into microwaves, or a resonance scheme.

The electromagnetic induction scheme, which exchanges power between a primary coil and a secondary coil, uses a principle that if a magnet is moved around a coil, an induced current occurs on the coil, thereby generating electricity. In this scheme, by generating magnetic waves, a transmitter produces electrical energy for a receiver, serving as a magnet. This phenomenon is called electromagnetic induction. Due to its excellent energy transmission efficiency, the electromagnetic induction scheme has been commercialized and applied to a variety of devices. For example, this scheme is applied to products such as electric razors and electric toothbrushes.

The resonance scheme uses sound resonance characteristics, i.e., when a tuning fork rings, a nearby wine glass may also ring at the same frequency. However, the resonance scheme resonates electromagnetic waves containing electrical energy instead of merely resonating sounds. The electromagnetic waves are directly delivered to the devices having a certain resonant frequency and the unused ones are reabsorbed as electromagnetic fields instead of being spread into the air, so they will not affect the nearby machines or human bodies, unlike other electromagnetic waves.

A Radio Frequency (RF)/microwave radiation scheme delivers energy by converting power energy into microwaves, which are favorable to wireless transmission. While common communication carries signals on carrier signals, the wireless power transmission, which sends electrical energy instead of the signals used in the wireless communication system such as radios and wireless phones, sends only the carriers.

The above-described wireless charging technologies have been applied to wireless electric toothbrushes, wireless shavers, and a rechargeable battery of a mobile phone. The battery of the mobile phone is automatically charged, when a user places the mobile phone on a charging pad, without connecting a separate charging connector thereto.

Among these wireless charging schemes, the resonance scheme generally includes a power supply device that supplies power and a power receiving device that receives power and charges a battery therein with the received power. The power supply device determines whether an object is placed on its source resonator (or Transmission (Tx) resonator) by measuring a change in load or a change in resonant frequency in a wireless charging standby state.

Upon detecting an object, the power supply device supplies power to the object by transmitting the power for charging, and determines whether the object is an object for wireless charging, or another metallic object, e.g., through an authentication process such as IDentifier (ID) exchange with the object. When the authentication is successful, the power supply device negotiates power transmission, determining that the object is an object capable of wireless charging.

When the negotiation is completed, the power receiving device starts charging. Thereafter, the power supply device determines whether the power receiving device is fully charged, and interrupts power transmission to the power receiving device, when the power receiving device is fully charged.

However, when supplying power, the power supply device continuously transmits the same level of power until the object is fully charged, which often wastes power. Specifically, the power supply device transmits an amount of power sufficient to charge a single device, even during the authentication and power transmission negotiation between the power supply device and the power receiving device, which wastes power.

Further, as a battery of a power receiving device is continually charged, the required power gradually reduces and a load of a source resonator increases, such that the power required by the power receiving device reduces. However, in the existing wireless power charging systems, the power transmitted by the power supply device is not adjusted in accordance with the required power of the power receiving device, thereby wasting power. Additionally, idle power will dissipate as heat at an amplifier of the power supply device, thereby wasting more power.

### SUMMARY OF THE INVENTION

Accordingly, the present invention is designed to address at least the problems and/or disadvantages described above and to provide at least the advantages described below.

An aspect of the present invention is to provide a method and apparatus that reduce power waste during charging in a wireless power charging system.

Another aspect of the present invention is to provide a method and apparatus that supply appropriate power when detecting an object, registering a power receiving device as a power supply target, and negotiating power transmission.

Another aspect of the present invention is to provide a method and apparatus that adjust supplied power, based on a charging state of a power receiving device.

In accordance with an aspect of the present invention, a wireless charging method is provided for a power supply device to wirelessly supply power to a power receiving device in a wireless power charging system. The wireless charging method includes checking an amount of charging power required by the power receiving device; determining a power level of the charging power that to be supplied over time, based on the amount of the charging power required by the power receiving device; transmitting the charging power corresponding to the determined power level to the power receiving device; periodically receiving a report message about a charging situation of the power receiving device from the power receiving device; calculating remaining required power, based on the report message received from the power receiving device; adjusting the determined power level depending on the calculated remaining power; and transmitting the charging power corresponding to the adjusted power level to the power receiving device.

In accordance with another aspect of the present invention, a power supply device is provided for wirelessly supplying power to a power receiving device in a wireless power charging system. The power supply device includes a source resonator for transmitting power; a communication unit for periodically receiving a report message about a charging situation of the power receiving device from the power receiving device; and a controller for checking an amount of charging power required by the power receiving device, determining a power level of the charging power to be supplied over time, based on the amount of the charging power required by the power receiving device, transmitting the charging power corresponding to the determined power level to the power receiving device; periodically receiving a report message about a charging situation of the power receiving device from the power receiving device; calculating remaining required power, based on the report message received from the power receiving device; adjusting the determined power level depending on the calculated remaining power; and transmitting the charging power corresponding to the adjusted power level to the power receiving device.

### BRIEF DESCRIPTION OF THE DRAWINGS

The above and other aspects, features, and advantages of certain embodiments of the present invention will be more apparent from the following description taken in conjunction with the accompanying drawings, in which:

FIG. 1 illustrates a power supply device according to an embodiment of the present invention;

FIG. 2 illustrates a power receiving device according to an embodiment of the present invention;

FIG. 3 illustrates a conventional power supply pattern during wireless charging;

FIG. 4 illustrates a power supply pattern in a wireless charging process according to an embodiment of the present invention;

FIG. 5 is a flowchart illustrating a process for supplying power in a power supply device according to an embodiment of the present invention;

FIG. 6 illustrates a power supply pattern in a device detection state according to an embodiment of the present invention;

FIG. 7 illustrates a power supply pattern in registration and configuration states according to an embodiment of the present invention;

FIG. 8 illustrates a power supply pattern in a charge state according to an embodiment of the present invention; and

FIG. 9 illustrates a power supply pattern for supplying power to a plurality of power receiving devices according to an embodiment of the present invention.

Throughout the drawings, the same drawing reference numerals will be understood to refer to the same elements, features and structures.

### DETAILED DESCRIPTION OF EMBODIMENTS OF THE INVENTION

Various embodiments of the present invention will now be described in detail below with reference to the accompanying drawings. In the following description, specific details such as detailed configuration and components are provided to assist the overall understanding of certain embodiments of the present invention. Therefore, it should be apparent to those skilled in the art that various changes and modifications of the embodiments described herein can be made without departing from the scope and spirit of the present invention. In addition, descriptions of well-known functions and constructions are omitted for clarity and conciseness.

In accordance with an embodiment of the present invention, a method and apparatus are provided for wireless charging with minimized waste of power in a wireless power charging system, wherein a power supply device adjusts the amount of power supplied to a power receiving device, based on the charging process. More specifically, the power supply device periodically transmits device detection power, which is the minimum power capable of device detection, in order to detect a power receiving device. Upon detecting the power receiving device, the power supply device transmits a driving power, which is sufficient for driving a charging module of the power receiving device, and then supplies a required amount of charging power to the power receiving device, if transmission of charging power to the power receiving device is determined. Basically, the power supply device gradually reduces the amount of charging power by monitoring the charging level of the power receiving device. This charging process is performed for each power receiving device individually.

Herein, a wireless charging process is divided into a detection state, a registration state, a configuration state, a charge state, and a standby state. Each state is a sub process given by dividing the wireless charging process on the basis of a power receiving device. In the detection state, a power supply device detects nearby candidate device(s), which are estimated to be capable of wireless charging. In the registration state, a power receiving device is registered in the power supply device as a wireless charging target device. In the configuration state, a wireless charging environment is set for wireless charging between the power supply device and the power receiving device. In the charge state, the power receiving device is charged with charging power supplied from the power supply device. In the standby state, the power supply device and/or the power receiving device wait for switching to the charge state, after the setting of the wireless charging environment is completed, or the power receiving device is not separated from the power supply device despite the completion of its charging. Depending on the power supply situation, switching from the configuration state to the charge state, without the standby state, is also possible.

As described above, each of the states is defined on the basis of a power receiving device. Thus, if a power supply device supplies power to a plurality of power receiving devices, a plurality of different states may coexist at the same time.

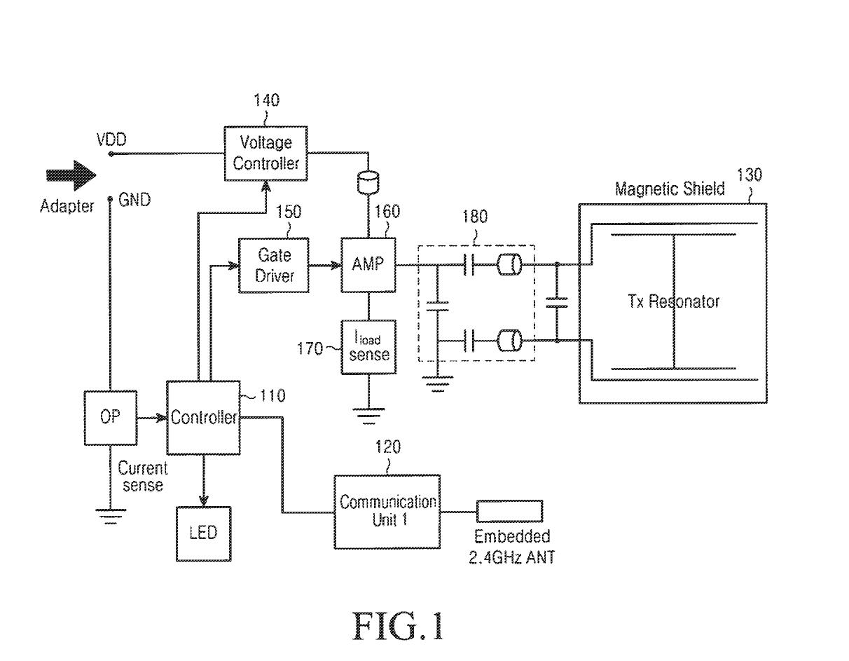

FIG. 1 illustrates a power supply device according to an embodiment of the present invention.

Referring to FIG. 1, a power supply device includes a controller 110, a communication unit 120, a source resonator (or Tx resonator) 130, a voltage controller 140, a gate driver 150, an amplifier (AMP) 160, a load sensor 170, and a matching circuit 180.

The load sensor 170 measures a load value of the source resonator 130 and outputs the measured load value to the controller 110. When a metallic object is placed on a charging substrate of the source resonator 130, a load value of the source resonator 130, which is measured while supplying detection power, may be different from the most recently measured load value. Upon detecting a change in the load value, the controller 110 determines that a charging target device is placed on the top of the source resonator 130.

Herein, a charging system is configured such that a power receiving device is wirelessly charged by the power supply device, when the power receiving device is placed on the charging substrate, and therefore, a method of determining whether a power receiving device is placed on a charging substrate is assumed to use a change in load of the source resonator 130.

However, the wireless resonance charging scheme, unlike the electromagnetic induction scheme, can supply power to a power receiving device placed within a predetermined distance, even though the power receiving device is not actually placed on a charging substrate of a power supply device. In this case, matching is performed, based on the distance between the power supply device and the associated power receiving device to make resonance for wireless charging occur.

The controller 110 controls the overall operation of the power supply device, including operations of each of the components of the power supply device, based on the progress of wireless charging. The controller 110 generates a variety of messages for wireless charging, and handles messages received from a power receiving device. Throughout the charging process, the controller 110 calculates an amount of supply power to be transmitted (or output) through the source resonator 130, based on information received from the load sensor 170 and other sensors and information received from the power receiving device. Further, the controller 110 controls the gate driver 150 and the voltage controller 140 so that the calculated amount of supply power is transmitted through the source resonator 130. The controller 110 determines a resonant frequency to be used during wireless charging for each power receiving device, and sets a resonant frequency of the source resonator 130 depending on the determined resonant frequency.

The matching circuit 180 matches an output impedance of the amplifier 160 with an input impedance of the source resonator 130, in order to prevent the degradation in transmission efficiency of the amplifier 160 due to the impedance mismatch. The input impedance of the source resonator 130 is variable depending on the change in the number of power receiving devices placed on the charging panel and the change in load of the source resonator 130. As a result, the input impedance may be variably driven by an adaptive matching circuit.

The source resonator 130 includes a resonant coil, and transmits energy, i.e., supply power, based on magnetic fields by evanescent wave coupling if it resonates at the same frequency as that of a target resonator in the power receiving device. The source resonator 130 includes a charging substrate on which a power receiving device is placed.

The communication unit 120, under control of the controller 110, outputs a received message to the controller 110, and sends a message received from the controller 110 to an external device by communicating with a power receiving device. For example, the communication unit 120 may be a ZigBee® communication transceiver, a Bluetooth® communication transceiver, an Infrared Data Association (IrDA)® communication transceiver, etc.

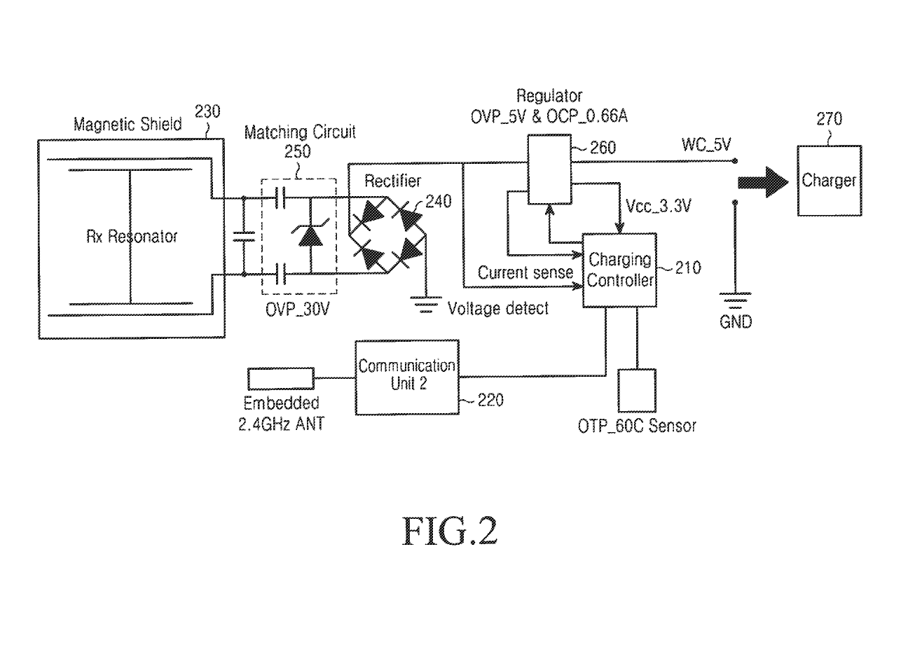

FIG. 2 illustrates a power receiving device according to an embodiment of the present invention.

Referring to FIG. 2, a power receiving device includes a charging controller 210, a communication unit 220, a target resonator (or Reception (Rx) resonator) 230, a rectifier 240, a matching circuit 250, a regulator 260, and a charger (or rechargeable battery) 270. The power receiving device may be included in a wide variety of portable terminals. For example, the power receiving device may be coupled to a portable terminal such as a mobile communication terminal, a smart phone, a portable game console, a Portable Multimedia Player (PMP), a navigation terminal, a digital camera, or a music player, to charge the charger 270 of the portable terminal.

The target resonator 230 includes a resonant coil, which resonates at the same frequency as that of the source resonator 130 of the power supply device 100 and receives supply power from the source resonator 130 through the resonant frequency.

The matching circuit 250 matches an output impedance of the target resonator 230 with an input impedance of the rectifier 240, but may be omitted, if the target resonator 230 has its own impedance matching circuit.

The rectifier 240 rectifies output signals of the matching circuit 250 and outputs the rectified signals to the regulator 260.

The regulator 260 regulates a voltage of the output signals of the rectifier 240, outputs a part of the regulated voltage as an operating voltage of the charging controller 210, and outputs the remaining part of the regulated voltage to the charger 270 as a charging voltage. Accordingly, the charger 270, for example, a rechargeable battery, is charged.

The charging controller 210 controls the overall operation of the power receiving device, and controls the operations of each of the components of the power receiving device, based on the progress of wireless charging. The charging controller 210 generates a variety of messages for wireless charging, and handles messages received from the power supply device.

Upon receiving a driving voltage from the regulator 260, the charging controller 210 activates the overall operation of the power receiving device. While the wireless charging is in progress, the charging controller 210 measures current and voltage of the signals output from the rectifier 240, and controls an operation of the regulator 260 according to the measurement results. The charging controller 210 determines a resonant frequency it will use during wireless charging with the power supply device, and sets a resonant frequency of the target resonator 230, based on the determined resonant frequency.

The communication unit 220, under control of the charging controller 210, outputs a message received from the external to the charging controller 210, and sends a message received from the charging controller 210 to an external device, e.g., by communicating with the power supply device. For example, the communication unit 220 may be a ZigBee® communication module, a Bluetooth® communication module, an IrDA® communication module, etc.

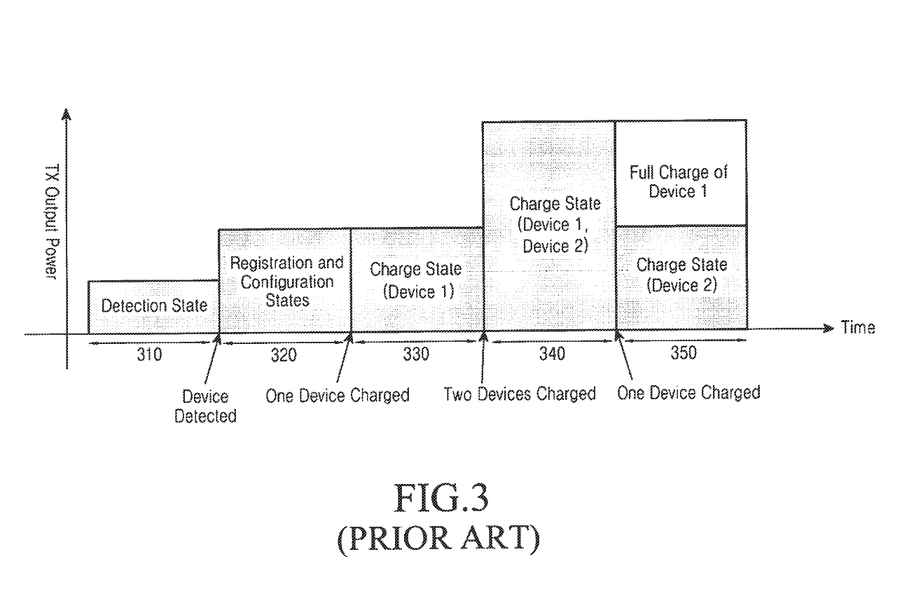

FIG. 3 schematically illustrates a conventional power supply pattern during wireless charging. Specifically, FIG. 3 shows an amount ‘Tx Output Power’ of supply power of a power supply device over time.

Referring to FIG. 3, the power supply device continuously transmits a predetermined amount of power for a first period 310 in which it maintains the detection state for determining whether there is a power receiving device in its vicinity. Upon detecting a first power receiving device, the power supply device switches to the registration and configuration states and supplies driving power to the detected first power receiving device for a second period 320.

Upon receiving the driving power from the power supply device, the first power receiving device activates the power supply device and exchanges messages needed for the registration and configuration for wireless charging, with the power supply device. For example, a registration request message for registering a power receiving device in a power supply device as a charging target device, a response message thereto (i.e., a registration request response message), a configuration message for negotiating the required amount of charging power, and a response message thereto (i.e., a configuration response message) may be exchanged between the power supply device and the power receiving device.

The second period 320, in which the driving power is supplied, is maintained until the power receiving device is normally registered in the power supply device after the exchanges of the above-described messages are completed, and then the wireless charging is started, after the configuration for wireless charging is completed.

If the registration and configuration for wireless charging is completed, the power supply device switches to the charge state and transmits charging power to the first power receiving device until the first power receiving device is fully charged, i.e., for third and fourth periods 330 and 340. If the first power receiving device is fully charged, the transmission of the charging power being supplied to the first power receiving device is interrupted in a fifth period 350.

As illustrated in FIG. 3, the driving power and charging power transmitted in each period is the same. However, the driving power that the first power receiving device requires is normally less than the charging power. As a result, power is wasted during the registration and configuration states.

After charging is started, the power stored in a charger of the power receiving device increases with the passage of time. As a result, the required power may be reduced gradually. However, as illustrated in FIG. 3, the level of the charging power supplied in the third period 330, in which only the first power receiving device is charging, is evenly maintained. The same is true, even in the fourth period 340, when multiple power receiving devices (for example, first and second power receiving devices) are simultaneously charged. Therefore, power is also wasted in periods 330, 340, and 350, where the charge state is maintained at the same level, regardless of the charging states of the power receiving devices.

Therefore, in accordance with an embodiment of the present invention, power wasting is reduced, by a power supply device varying an amount of charging power supplied to a power receiving device.

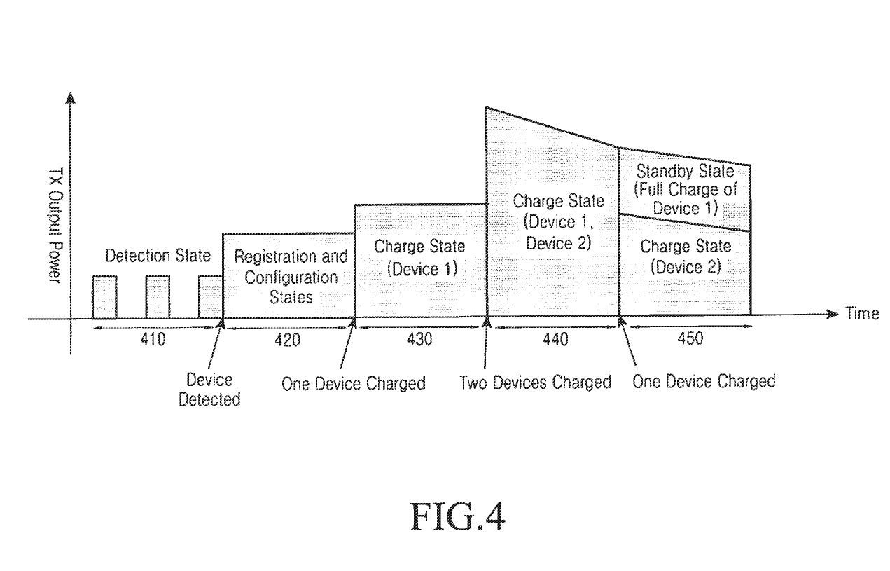

FIG. 4 illustrates a power supply pattern during wireless charging according to an embodiment of the present invention. Specifically, FIG. 4 illustrates an amount ‘Tx Output Power’ of supply power of a power supply device over time.

Referring to FIG. 4, the power supply device transmits a minimum amount of detection power that is capable of determining whether a candidate device for wireless charging is in its vicinity, at stated intervals in period 410, i.e., during the detection state. Basically, the power supply device transmits the detection power at stated intervals in period 410, instead of continuously transmitting the detection power.

Upon detecting a change in load or a change in resonant frequency while transmitting the detection power, the power supply device 100 determines that a metallic device(s) within a range in which wireless charging is possible. The power supply device determines whether the device is a power receiving device, and at the same time, starts transmitting driving power for driving of the power receiving device, switching to the registration state.

If the device is capable of wireless charging, it can receive driving power, and the device is activated. Therefore, it is preferable that an amount of driving power transmitted corresponds to an amount of power actually required to activate and operate a power receiving device. For example, the driving power of the power receiving device may be determined in advance as a specific value.

The power receiving device (Device 1) is activated by receiving the driving power, exchanges a variety of messages with the power supply device, registers itself in the power supply device, and sets a configuration for wireless charging. The power supply device determines a level ‘a’ of charging power it will supply to the power receiving device.

Accordingly, period 420, i.e., the registration and configuration states, is maintained until the wireless charging starts. and during the period 420, driving power is transmitted.

In order to start wireless charging of the power receiving device, the power supply device starts transmitting the charging power that was negotiated during configuration for wireless charging, thereby switching to the charge state. The power receiving device periodically reports the amount of power that has been charged, or the remaining amount of charging power that is still needed, to the power supply device. As described above, the power required for charging reduces gradually as the charging of the power receiving device is in progress. Therefore, in accordance with an embodiment of the present invention, the power supply device gradually reduces the charging power that is transmitted to the power receiving device over time, depending on the reported amount of charging power. Specifically, the power supply device reduces the level of the charging power that is to be supplied to the power receiving device over time, depending on the required amount of charging power of the power receiving device.

In period 430, wherein the actual charging for the power receiving device is performed, a predetermined amount of charging power is transmitted, but in period 440, a level of the charging power that is transmitted over time is gradually reduced. Although the total amount of charging power increases in the period 440 because two power receiving devices are simultaneously charged, as another power receiving device (Device 2) is added, the charting power that is transmitted in period 440 is not evenly maintained, based on the charging situation of the power receiving device (Device 1).

Thereafter, when the charging of Device 1 is completed, in period 450, the power supply device switches to the standby state for Device 1 by interrupting its transmission of the charging power to Device 1, but still maintains transmission of the driving power until the Device 1 is removed from the charging target. If the power transmission to Device 1 is completely interrupted, the Device 1 may alternately repeat the full charging and the complementary charging.

Further, in period 450, because the charging of Device 2 is continuously performed, the power supply device maintains the charge state for supplying charging power, with respect to Device 2.

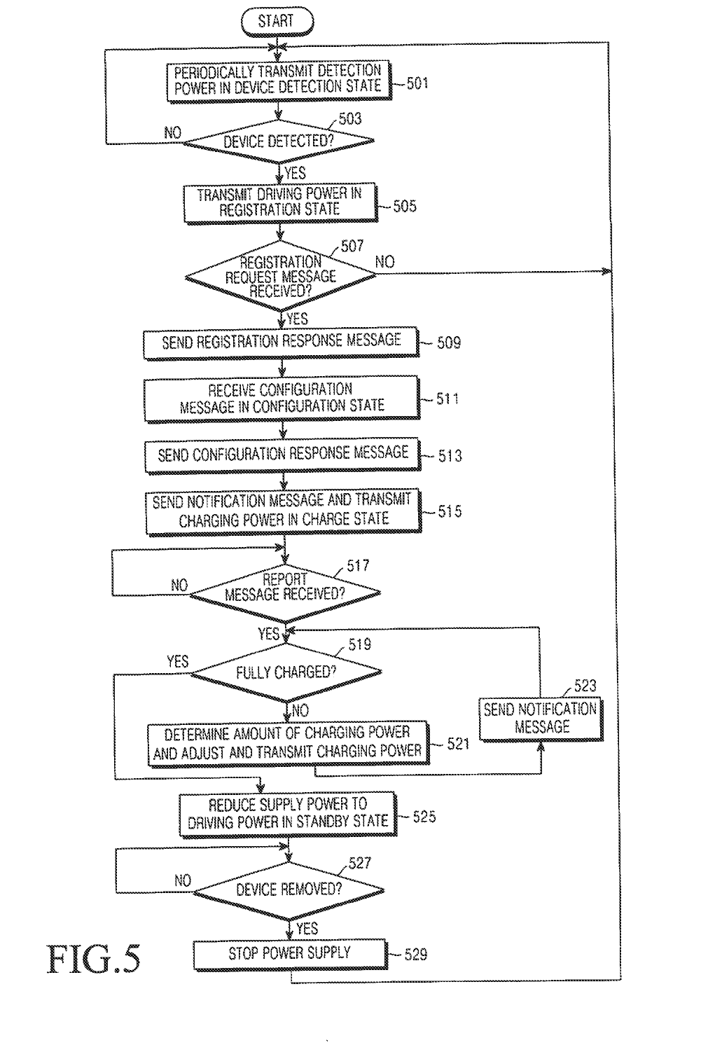

FIG. 5 is a flowchart illustrating a process for supplying power in a power supply device according to an embodiment of the present invention.

Referring to FIG. 5, in step 501, the power supply device periodically transmits detection power and determines if a power receiving device is detected within a valid range, where it can wirelessly supply power, e.g., if a power receiving device is placed onto a charging substrate of a source resonator.

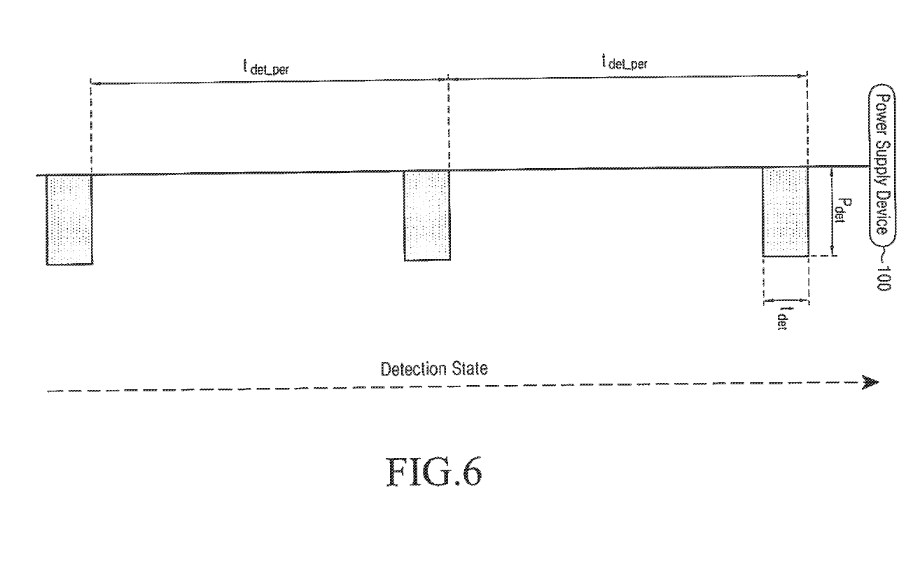

FIG. 6 illustrates a power supply pattern in a device detection state according to an embodiment of the present invention.

Referring to FIG. 6, the power supply device maintains the detection state in which it transmits a detection power P_{det} for a valid detection period t_{det} in every predetermined detection period t_{det}_{_{—}}ₚₑᵣ. A level of the detection power and a length of the valid detection period are determined depending on the required minimum amount of power and time by which the power supply device can detect a change in load of its source resonator and determine whether a candidate device for wireless charging exists within the valid range. That is, to detect a candidate device, i.e., a metallic object, the power supply device simply detects a change in load of a source resonator. Therefore, the power consumption in the detection state may be minimized by periodically generating a sine wave of a low voltage having a level sufficient to detect a load value of the source resonator for a short time that is sufficient to detect a load value of the source resonator. The detection state is maintained until a new device is detected for a valid detection period.

Referring back to FIG. 5, upon detecting a device in step 503, the power supply device 100 transmits driving power in step 505, thereby switching to the registration state. A resonant frequency used to transmit the driving power is a fundamental frequency that is predetermined between the power supply device and power receiving devices. The power supply device uses the fundamental frequency as a resonant frequency to transmit driving power. Thereafter, in the configuration process, the power supply device may determine a resonant frequency for transmitting charging power.

In step 507, the power supply device determines whether a registration request message is received within a predetermined period, and if the registration request message is not received, the process returns to step 501, determining that the detected device is not capable of wireless charging.

For example, a registration request message includes identification information and a registration request of the power receiving device. The identification information may be, for example, a serial number of the power receiving device.

Upon receiving the registration request message within the predetermined period, the power supply device checks the identification information of the power receiving device, which is included in the registration request message, to determine whether the power receiving device is a device capable of wireless charging. If the power receiving device is a device capable of wireless charging, the power supply device registers the power receiving device as a charging target device.

In step 509, the power supply device generates a registration response message including registration success information and sends it to the power receiving device. However, when the power receiving device is incapable of wireless charging, the power supply device generates a registration response message including wireless charging impossibility information and sends it to the power receiving device. Thereafter, although not illustrated, the power supply device may receive an Acknowledgement (ACK) from the power receiving device.

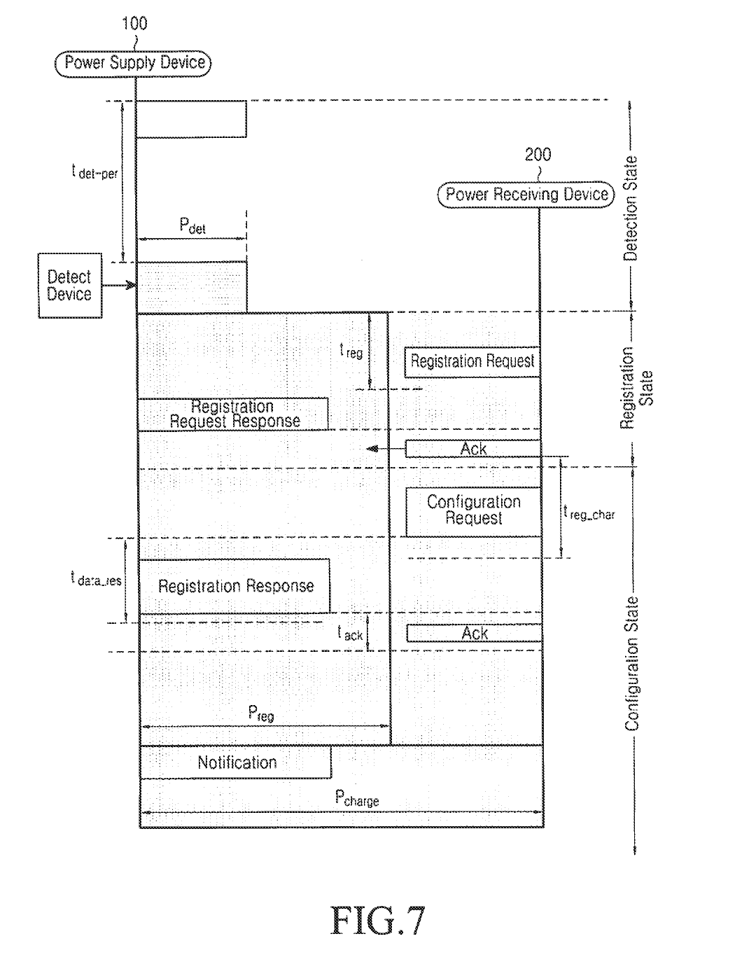

FIG. 7 illustrates a power supply pattern in registration and configuration states according to an embodiment of the present invention.

Referring to FIG. 7, upon detecting a device within a valid detection period, the power supply device 100 transmits driving power P_{reg}, and then waits for reception of a registration request message for a valid registration period t_{reg}. Herein, an amount of driving power transmitted is determined as a level that a power receiving device needs to operate by being activated. For example, the driving power may be determined in advance as a specific value or amount of power by which the charging controller 210 and the communication unit 220 can normally operate by being activated.

Upon receiving the driving power, the power receiving device 200 activates the charging controller 210 and the communication unit 220 and sends a registration request message through the communication unit 220. As the registration request message is received within a valid registration period, the power supply device 100 generates a registration request response message and sends it to the power receiving device 200 through the communication unit 110.

Upon receiving the registration request response message, the power receiving device 200 sends an ACK to the power supply device 100. The power supply device 100 determines whether the ACK is received, for an ACK period t_{ack}.

Referring back to FIG. 5, upon receiving an ACK, the power supply device switches to the configuration state and receives a configuration message from the power receiving device within a predetermined period, in step 511. The configuration message includes information about a required amount of charging power, which indicates the required amount of charging power of the power receiving device, a supportable resonant frequency range, and a level of an amount of power that can be received over time.

The power supply device compares the amount of power it can supply presently, with the required amount of charging power of the power receiving device, and determines whether power supply is possible. In particular, if the power supply device is presently supplying power to another power receiving device, the power supply device may not afford to additionally supply power.

However, if transmission of the charging power is started, the power supply device may approximately predict the charge completion time of each power receiving device because it receives a report message indicating the charging situation from the power receiving device. Therefore, if it is predicted that the power supply device can secure charging power of the power receiving device within a predetermined waiting period, the power supply device determines that it can supply charging power to the power receiving device. If there is no power receiving device that is fully charged within the waiting period, the power supply device determines that power supply is not possible.

When the power supply is possible, the power supply device assigns a device identifier to the power receiving device, determines a resonant frequency to be used during supply of charging power, allocates a time slot for communication with the power receiving device, and determines a level of the charging power that is to be supplied to the power receiving device. The device identifier is used to identify the power receiving device in the subsequent charging process. The resonant frequency is determined within a frequency range where support of the power receiving device is possible. The time slot is to smooth communication with each power receiving device when the power supply device supplies power to multiple power receiving devices.

For example, when a maximum amount of supply power that the power supply device can supply per time is 15w, and the power supply device is presently transmitting power of 7w for other purposes, then a level of the charging power that the power supply device can supply to the power receiving device may be determined to be less than 8w.

In step 513, the power supply device generates a configuration response message including a device identifier, an allocated time slot, a resonance frequency, and a chargeability indicator, and sends it to the power receiving device. Thereafter, although not illustrated, the power supply device may receive an ACK from the power receiving device.

If the power receiving device requires transmission of the power that exceeds the charging capacity of the power supply device, the power supply device generates a configuration response message including charging impossibility information, sends it to the power receiving device, and interrupts the power transmission to the power receiving device. For example, if the maximum amount of supply power that the power supply device can supply per time is 15w, but the power receiving device requires 20w, then the power supply device sends a visual or auditory error message to the user, without approving the power receiving device, indicating that the power receiving device cannot be charged, because the required power exceeds the possible power capacity.

Referring again to FIG. 7, after receiving an ACK for the registration request response message, the power supply device 100 waits for reception of a configuration message (or a configuration request message) from the power receiving device 200 for a valid configuration period t_{reg}_{_{—}}_{char}.

After sending an ACK for the registration request response message, the power receiving device 200 determines the required amount of charging power by checking the charging state of the charger 270, generates a configuration message, and sends it to the power supply device 100.

Upon receiving the configuration message from the power receiving device 200, the power supply device 100 generates the above-described configuration response message and sends it to the power receiving device 200 for a valid configuration response period t_{data}_{_{—}}ᵣₑₛ.

Upon receiving the configuration response message, the power receiving device 200 sends an ACK to the power supply device 100. The power supply device 100 determines whether the ACK is received, for an ACK period t_{ack}.

As illustrated in FIG. 7, during the registration and configuration states, the power supply device 100 transmits only the power (i.e., driving power) for communication with the power receiving device 200 to the power receiving device 200, because the power supply device 100 does not need to transmit the power for actually charging. Specifically, the power supply device 100 transmits only the power needed to operate the charging controller 210 and the second communication unit 220 of the power receiving device 200, thereby minimizing power waste.

Referring again to FIG. 5, in step 515, the power supply device sends a notification message indicating the charging start to the power receiving device, and starts transmission of the charging power, thereby switching to the charge state. The notification message includes information to be notified to the power receiving device during the charge state, or that is used to require transmission of a report message. For example, when the time slot allocated to the power receiving device changes, the notification message may include information about a newly allocated time slot. The new allocation of a time slot may occur, if the number of devices being charged changes. Upon receiving the notification message, the power receiving device sends a report message.

In step 517, the power supply device determines whether a report message is received from the power receiving device. The report message reports a charging level of a charger (rechargeable battery) in the power receiving device.

In step 519, after the report message is received, the power supply device determines whether the power receiving device is fully charged by checking information in the report message.

If the power receiving device is not fully charged, the power supply device determines the remaining amount of charging power for the charger in step 521, which is included in the report message, and maintains the previous level of charging power, if the remaining amount of charging power of the power receiving device is greater than a level of charging power that is supplied to the power receiving device per time. However, if the remaining amount of charging power of the power receiving device is less than a level of the charging power that is supplied to the power receiving device, the power supply device decreases a level of the charging power, in order to prevent power waste. Accordingly, the power supply device determines a level of the charging power that is supplied to the power receiving device over time, and transmits the determined charging power.

In step 523, the power supply device sends a notification message to the power receiving device, inducing transmission of a report message. For example, the notification message may be sent at regular intervals.

Upon receiving the notification message, the power receiving device generates a report message and sends it to the power supply device.

In accordance with another embodiment of the present invention, the power supply device may transmit information for requesting periodic transmission of a report message to the power receiving device using a notification message, so the power receiving device may spontaneously send a report message to the power supply device at regular intervals.

When the report message includes information indicating that the power receiving device is fully charged in step 519, the power supply device switches to the standby state, in which it reduces the supply power to the power receiving device down to the driving power, in step 525. This is because if the power supplied to the charging controller 210 of the power receiving device 200 is completely blocked, the power receiving device 200 may alternately repeat the full charging and the complementary charging, causing confusion to the user.

In step 527, in the standby state, the power supply device determines whether the power receiving device is removed from the charging target, and if the power receiving device is removed, the power supply device interrupts the power supply in step 529, thereby switching back to the detection state. For example, the power supply device continuously sends a notification message to the power receiving device, even in the standby state, inducing transmission of a report message after sending a notification message, and then determines that the power receiving device is removed, upon failure to receive a report message corresponding thereto over a predetermined period of time.

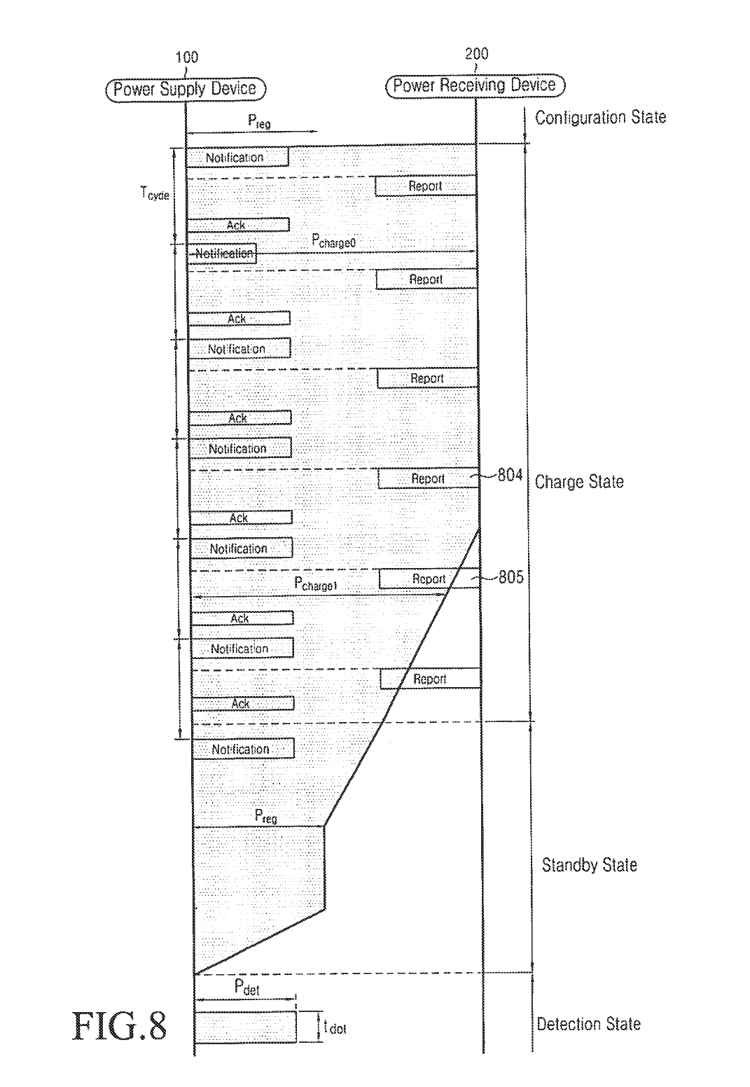

FIG. 8 illustrates a power supply pattern in a charge state according to an embodiment of the present invention. Specifically, FIG. 8 illustrates a power supply pattern corresponding to steps 515 to 529 in FIG. 5.

Referring to FIG. 8, the power supply device 100 sends a notification message indicating the charging start to the power receiving device 200, and starts transmitting charging power P_{charge0} determined in the configuration state, thereby switching to the charge state.

Upon receiving the notification message, the power receiving device 200 sends a report message, and the power supply device 100 sends an ACK for the notification message to the power receiving device 200. The power supply device 100 sends a notification message to the power receiving device 200 in every predetermined cycle t_{cycle}, and receives a report message corresponding thereto, to determine the charging situation of the power receiving device 200.

In FIG. 8, it is assumed that the remaining amount of charging power of the power receiving device 200, which is included in a fourth report message 804, is less than the charging power P_{charge0}. Accordingly, the power supply device 100 then gradually reduces the charging power to the power receiving device 200.

Upon receiving a fifth report message 805, the power supply device 100 compares the remaining amount of charging power of the power receiving device 200, which is included in the fifth report message 805, with the charging power P_{charge1} for the power receiving device 200, that the power supplying device 100 is presently transmitting. If the charging power P_{charge1} is greater than the remaining amount of charging power of the power receiving device 200, the power supply device 100 maintains the charging power P_{charge1}. However, if the charging power P_{charge1} is less than or equal to the remaining amount of charging power of the power receiving device 200, the power supply device 100 continuously reduces the charging power.

When a received report message includes information indicating a full charge, the power supply device 100 switches to the standby state and reduces the supply power corresponding to the power receiving device 200 down to the driving power P_{reg}. Even in the standby state, the power supply device 100 sends a notification message to the power receiving device 200, requesting the power receiving device 200 to send a report message. Then, upon failure to receive a report message from the power receiving device 200 for predetermined period, after sending a notification message, the power supply device 100 determines that the power receiving device 200 is removed from the top of the charging substrate.

Upon detecting the removal of the power receiving device 200, the power supply device 100 gradually reduces the amount of supply power corresponding to the power receiving device 200 to interrupt the power supply, and switches back to the detection state.

In the description of FIGS. 5 to 8 above, it is assumed that the power supply device detects one power receiving device, and does not perform power supply to another power receiving device, until the first detected power receiving device is excluded from the power supply range of the power supply device, after it is fully charged. However, even if multiple power receiving devices are placed on the charging substrate of the power supply device, the same process as that described above may be simultaneously performed for each of the power receiving devices.

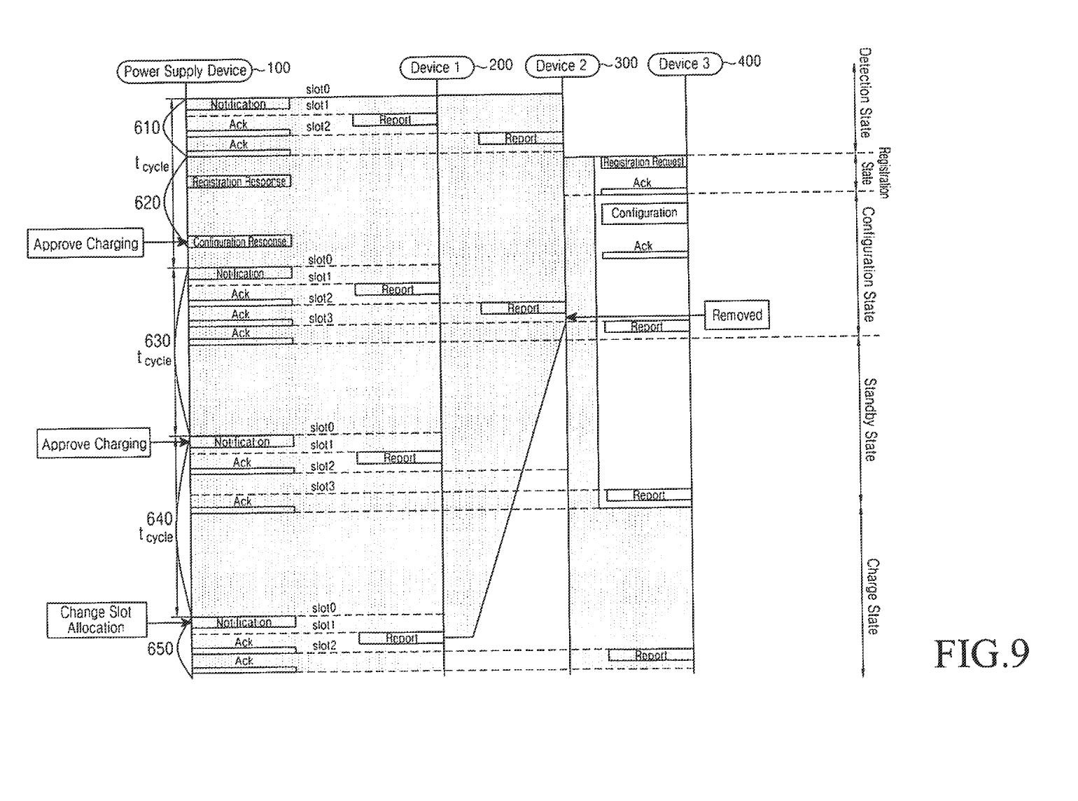

FIG. 9 illustrates a power supply pattern for supplying power to a plurality of power receiving devices according to an embodiment of the present invention.

In FIG. 9, a second power receiving device 300 and a third power receiving device 400 are similar in structure to the first power receiving device 200, as illustrated in FIG. 2. Further, in FIG. 9, the first power receiving device 200 is receiving charging power in the charge state and the second power receiving device 300 is suddenly removed while being charged. In addition, the third power receiving device 400 is newly detected and receives power, while the first and second power receiving devices 200 and 300 are being charged. Each state illustrated in FIG. 9 is associated with the third power receiving device 400.

Under these assumptions, the first and second power receiving devices 200 and 300 each send a report message in response to a notification message from the power supply device 100. The power supply device 100 uses a first time slot slot0, and the first power receiving device 200 uses a second time slot slot1. The power supply device 100 supplies charging power to the first and second power receiving devices 200 and 300, and at the same time, transmits detection power, in period 610.

Upon receiving a new device, i.e., the third power receiving device 400, the power supply device 100 transmits driving power corresponding to the third power receiving device 400. Accordingly, the third power receiving device 400 sends a registration request message to the power supply device 100, and the power supply device 100 generates a registration response message and sends it to the third power receiving device 400, performing device registration, in period 620.

The third power receiving device 400 sends a configuration message to the power supply device 100, requesting power supply. The power supply device 100 may not have the charging power secured to be supplied to the third power receiving device 400, because it is transmitting charging power to the first and second power receiving devices 200 and 300. However, the power supply device 100 may approximately predict the charge completion time of each power receiving device, based on the report messages received from the first and second power receiving devices 200 and 300. Therefore, if it is predicted that the power supply device 100 cannot secure the charging power of the third power receiving device 400 within a predetermined period, the power supply device 100 assigns a device identifier to the third power receiving device 400, determining that the charging power supply to the third power receiving device 400 will be possible, allocates a fourth time slot slot3 for communication with the third power receiving device 400, and determines a level of the charging power that is to be supplied to the third power receiving device 400 per time. The power supply device 100 then generates a configuration response message including a device identifier, an allocated time slot, and a chargeability indicator, and sends it to the third power receiving device 400, in period 620.

If the power supply device 100 has secured the charging power to be supplied to the third power receiving device 400, the power supply device 100 starts transmitting the charging power within a short time, upon receiving an ACK corresponding to the configuration response message from the third power receiving device 400. However, if the power supply device 100 has not secured the charging power to be supplied to the third power receiving device 400, the power supply device 100 waits to transmit charging power until the charging power is secured, for example, until the charging of the power receiving device(s) presently being charged is completed or the power receiving device is removed, in period 630.

The power supply device 100 then requests transmission of a report message using a notification message. In response, the first, second, and third power receiving devices 200, 300, and 400 each send a report message in their allocated time slot, and receive an ACK corresponding thereto from the power supply device 100, in period 630.

However, the second power receiving device 300 may be removed from the charging target of the power supply device 100, even though its charging is not completed. For example, the second power receiving device 300 is removed from the charging substrate while it is being charged.

Upon detecting the removal of the second power receiving device 300, the power supply device 100 gradually reduces the supply power being transmitted to the second power receiving device 300, in period 630.

Accordingly, the charging power to be supplied to the third power receiving device 400 may be secured, and the power supply device 100 starts transmission of charging power to the third power receiving device 400 in period 640.

Thereafter, the power supply device 100 newly allocates time slots, and transmits the time slot allocation information to the first and third power receiving devices 200 and 400 using a notification message in period 650.

As is apparent from the foregoing description, the above-described embodiments of present invention provide methods and apparatuses that reducing power waste during wireless charging. The methods and apparatuses supply a required amount of power when detecting an object by a power supply device, registering a power receiving device as a power supply target, and negotiating power transmission. Further, the methods and apparatuses can adjust an amount of power that a power supply device supplies, based on the charging state of a power receiving device.

While the present invention has been shown and described with reference to certain embodiments thereof, it will be understood by those skilled in the art that various changes in form and details may be made therein without departing from the spirit and scope of the present invention as defined by the appended claims and their equivalents.

What is claimed is:

1. A wireless charging method by a power supply device for wirelessly supplying power to a power receiving device in a wireless power charging system, the wireless charging method comprising:
checking an amount of charging power required by the power receiving device;
determining a power level of the charging power to be supplied over time, based on the amount of the charging power required by the power receiving device;
transmitting the charging power corresponding to the determined power level to the power receiving device;
periodically receiving a report message about a charging situation of the power receiving device from the power receiving device;
calculating remaining required power, based on the report message received from the power receiving device;
adjusting the determined power level depending on the calculated remaining power; and
transmitting the charging power corresponding to the adjusted power level to the power receiving device.

2. The wireless charging method of claim 1, wherein the report message includes information about a remaining amount of charging power of the power receiving device.

3. The wireless charging method of claim 1, wherein the report message includes information about a charging level of the power receiving device.

4. The wireless charging method of claim 1, further comprising:
reducing a total amount of supply power corresponding to the power receiving device to a level of a driving power, when the report message includes information indicating that a rechargeable battery of the power receiving device is fully charged.

5. The wireless charging method of claim 4, further comprising interrupting power transmission to the power receiving device, upon detecting removal of the power receiving device.

6. The wireless charging method of claim 1, further comprising:
periodically transmitting detection power for detecting a power receiving device;
measuring a load value of a source resonator of the power supply device for a first period in which the detection power is transmitted;
determining that the power receiving device is detected, when the measured load value is different from a load value of the source resonator, which has been most recently measured around the first period; and
transmitting driving power for driving the power receiving device,
wherein a level of the detection power is determined using a minimum voltage at which a change in the load of the source resonator can be detected, and a transmission maintenance period of the voltage.

7. The wireless charging method of claim 6, wherein a level of the driving power is sufficient for communication between the power supply device and an associated power receiving device, and to activate a communication function of the power supply device, and
wherein transmission of the driving power is maintained the power receiving device is removed.

8. The wireless charging method of claim 6, further comprising determining that the power receiving device is removed, upon failure to receive the report message for a predetermined period.

9. The wireless charging method of claim 1, wherein transmitting the charging power corresponding to the adjusted power level comprises:
checking a remaining amount of charging power of the power receiving device, in the report message; and
reducing a level of the charging power, if the level of the charging power is greater than the remaining amount of the charging power at a time of receiving the report message.

10. The wireless charging method of claim 9, wherein the report message is periodically received.

11. The wireless charging method of claim 1, further comprising transmitting a notification message to the power receiving device for requesting transmission of the report message.

12. A power supply device for wirelessly supplying power to a power receiving device in a wireless power charging system, the power supply device comprising:
a source resonator for transmitting power;
a communication unit for periodically receiving a report message about a charging situation of the power receiving device from the power receiving device; and
a controller for checking an amount of charging power required by the power receiving device, determining a power level of the charging power to be supplied over time, based on the amount of the charging power required by the power receiving device, transmitting the charging power corresponding to the determined power level to the power receiving device; periodically receiving a report message about a charging situation of the power receiving device from the power receiving device; calculating remaining required power, based on the report message received from the power receiving device; adjusting the determined power level depending on the calculated remaining power; and transmitting the charging power corresponding to the adjusted power level to the power receiving device.

13. The power supply device of claim 12, wherein the report message includes information about a remaining amount of charging power of the power receiving device.

14. The power supply device of claim 12, wherein the report message includes information about a charging level of the power receiving device.

15. The power supply device of claim 12, wherein the controller reduces a total amount of supply power corresponding to the power receiving device to a level of a driving power, when the report message includes information indicating that a rechargeable battery of the power receiving device is fully charged.

16. The power supply device of claim 15, wherein the controller interrupts power transmission to the power receiving device, upon detecting removal of the power receiving device.

17. The power supply device of claim 12, wherein the controller periodically transmits detection power for detecting a power receiving device, measures a load value of a source resonator of the power supply device for a first period in which the detection power is transmitted, determines that the power receiving device is detected, when the measured load value is different from a load value of the source resonator, which has been most recently measured around the first period, and transmits driving power for driving the power receiving device, and
wherein a level of the detection power is determined using a minimum voltage at which a change in the load of the source resonator can be detected, and a transmission maintenance period of the voltage.

18. The power supply device of claim 17, wherein a level of the driving power is sufficient for communication between the power supply device and an associated power receiving device, and to activate a communication function of the power supply device, and
wherein transmission of the driving power is maintained the power receiving device is removed.

19. The power supply device of claim 17, wherein the controller determines that the power receiving device is removed, upon failure to receive the report message for a predetermined period.

20. The power supply device of claim 12, wherein the controller checks a remaining amount of charging power of the power receiving device, in the report message, and reduces a level of the charging power, if the level of the charging power that is transmitted to the power receiving device is greater than the remaining amount of the charging power at a time of receiving the report message.
